(19) United States
(12) Patent Application Publication
(10) Pub. No.: US 2026/0158862 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Yong Woong Cha, Hwaseong-si (KR); Hochan An, Hwaseong-si (KR); Seong-Bin Jeong, Hwaseong-si (KR); Gwi Taek Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Yeon Ho Kim, Hwaseong-si (KR)

(73) Assignees: HYUNDAI MOTOR COMPANY, Seoul (KR); KIA CORPORATION, Seoul (KR)

(21) Appl. No.: 19/258,516

(22) Filed: Jul. 2, 2025

(30) Foreign Application Priority Data
Dec. 6, 2024 (KR) 10-2024-0181009

(51) Int. Cl. B60H 1/00

(52) U.S. Cl. CPC B60H 1/00899; B60H 1/00278; B60H 1/00328; B60H 1/00485

(57) ABSTRACT

A heat pump system for a vehicle is capable of improving cooling and heating performance by applying a gas injection device selectively operating in an air conditioning mode of the vehicle interior to increase the flow rate of the refrigerant. The heat pump system is further capable of reducing the manufacturing cost and reducing the weight by using a single heat-exchanger configured to exchange heat between at least two refrigerants having different temperatures and states with each other for the entire system. By implementing the gas injection device, the total number of the components may be reduced.

### CROSS-REFERENCE TO RELATED APPLICATION

This application claims priority to and the benefit of Korean Patent Application No. 10-2024-0181009, filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance.

### Description of the Related Art

An air conditioning system for a vehicle includes an air conditioner unit circulating a refrigerant in order to heat or cool an interior of a vehicle.

The air conditioner unit, which maintains the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by the driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used unlike an air conditioner of a general vehicle, and an air conditioner used in an environment-friendly vehicle is called a heat pump system.

An electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, each should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, for heating the vehicle interior, the heating performance may be deteriorated due to the lack of a heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known to those having ordinary skill in the art.

### SUMMARY

The present disclosure provides a heat pump system for a vehicle capable of improving cooling and heating performance by applying a gas injection device selectively operating in an air conditioning mode of the vehicle interior to increase the flow rate of the refrigerant.

In addition, the present disclosure provides a heat pump system for a vehicle capable of reducing the manufacturing cost and reducing the weight by using a single heat-exchanger configured to heat-exchange at least two refrigerants having different temperatures and states with each other for the entire system and the gas injection device, the total number of the components may be reduced.

A heat pump system for a vehicle includes a compressor configured to compress a refrigerant. The heat pump system further includes a condenser connected to the compressor through a refrigerant line, and configured to condense the refrigerant. The heat pump system further includes a first expansion valve connected to the condenser through the refrigerant line, and an evaporator connected to the first expansion valve through the refrigerant line, connected to the compressor through the refrigerant line, and configured to evaporate the supplied refrigerant. The heat pump system further includes a connection line having a first end connected to the refrigerant line between the condenser and the first expansion valve, and a second end connected to the refrigerant line between the compressor and the evaporator. The heat pump system further includes a chiller provided on the connection line, and configured to adjust a temperature of the coolant by heat-exchanging the refrigerant introduced through the connection line with a selectively introduced coolant. The heat pump system further includes a second expansion valve provided on the connection line at an upstream end of the chiller. The heat pump system further includes a heat-exchanger connected to the refrigerant line connecting the condenser and the first expansion valve, and the refrigerant line connecting the evaporator and the compressor. The heat pump system further includes a gas injection device including the heat-exchanger, provided on the refrigerant line between the condenser and the first expansion valve, and configured to expand the refrigerant selectively introduced from the condenser and supply the expanded refrigerant to the heat-exchanger, and to supply the refrigerant heat-exchanged in the heat-exchanger to the compressor, so as to increase the flow rate of the refrigerant circulating the refrigerant line. The flow rate of the refrigerant is controlled through an operation control of the gas injection device, based on at least one mode for adjusting a temperature of a vehicle interior.

The gas injection device may further include a first line having a first end connected to the refrigerant line between the condenser and the heat-exchanger, and a second end connected to the heat-exchanger. The gas injection device may further include a third expansion valve provided on the first line at an upstream end of the heat-exchanger The gas injection device may further include a second line having a first end connected to the heat-exchanger, and a second end connected to the compressor.

The heat-exchanger may include a first heat-exchange device configured to heat-exchange the refrigerant supplied from the condenser through the refrigerant line with the refrigerant supplied from the evaporator or the chiller. The heat-exchanger may further include a second heat-exchange device configured to heat-exchange the refrigerant supplied from the condenser through the refrigerant line, and the refrigerant expanded in the third expansion valve and supplied through the first line, with each other. The heat-exchanger may further include a barrier rib configured to partition the first heat-exchange device and the second heat-exchange device.

The barrier rib may be configured to allow the refrigerant supplied from the condenser to flow to the first heat-exchange device and the second heat-exchange device so that the refrigerant supplied from the condenser through the refrigerant line flows together in the first heat-exchange device and the second heat-exchange device, and prevent the refrigerant supplied from the evaporator or the chiller to the first heat-exchange device through the refrigerant line from being mixed with the refrigerant supplied from the third expansion valve to the second heat-exchange device through the first line.

When the refrigerant expanded in the third expansion valve is supplied to the heat-exchanger through the first line, the heat-exchanger may be configured to vaporize the refrigerant supplied from the third expansion valve through heat-exchange with the refrigerant supplied from the condenser so that the flow rate of the refrigerant circulating the refrigerant line is increased, and supply the vaporized refrigerant to the compressor through the second line.

When an operation of the gas injection device is required, the third expansion valve may be configured to expand the refrigerant supplied from the condenser through the first line, and supply the expanded refrigerant to the heat-exchanger.

The at least one mode may include a first cooling mode for cooling the vehicle interior and the gas injection device is not operated, a second cooling mode for cooling the vehicle interior and the gas injection device is operated, a first heating mode for heating the vehicle interior and the gas injection device is not operated, and a second heating mode for the heating the vehicle interior and the gas injection device is operated.

In the first cooling mode, the refrigerant line interconnecting the compressor, the condenser, the first expansion valve, the evaporator may be opened. The first line may be closed by the third expansion valve. The second line may be closed. The first expansion valve may expand the refrigerant introduced through the refrigerant line and may supply the expanded refrigerant to the evaporator. The third expansion valve may stop operating, and the heat-exchanger may heat-exchange the refrigerant passing through the first heat-exchange device from the condenser, and the refrigerant passing through the first heat-exchange device from the evaporator, with each other.

When cooling of a battery module is required in the first cooling mode, the connection line may be opened by the second expansion valve. The second expansion valve may expand the refrigerant introduced through the connection line and may supply the expanded refrigerant to the chiller The refrigerant having passed through the chiller may pass through the first heat-exchange device together with the refrigerant discharged from the evaporator.

In the second cooling mode, the refrigerant line interconnecting the compressor, the condenser, the first expansion valve, and the evaporator may be opened. The first line may be opened by the third expansion valve. The second line may be opened. The first expansion valve may expand the refrigerant introduced through the refrigerant line and may supply the expanded refrigerant to the evaporator. The third expansion valve may expand the refrigerant introduced through the first line, and may supply the expanded refrigerant to the heat-exchanger through the first line. The first heat-exchange device in the heat-exchanger may heat-exchange the refrigerant passing through the first heat-exchange device from the condenser, and the refrigerant passing through the first heat-exchange device from the evaporator, with each other. The second heat-exchange device in the heat-exchanger may heat-exchange the refrigerant passing through the second heat-exchange device from the condenser, and the refrigerant passing through the second heat-exchange device from the third expansion valve, with each other, and may supply the gaseous refrigerant to the compressor through the opened second line.

When cooling of a battery module is required in the second cooling mode, the connection line may be opened by the second expansion valve. The second expansion valve may expand the refrigerant introduced through the connection line and may supply the expanded refrigerant to the chiller, and the refrigerant having passed through the chiller may pass through the first heat-exchange device together with the refrigerant discharged from the evaporator.

In the first heating mode, a portion of the refrigerant line connecting the compressor and the condenser may be opened. A portion of the refrigerant line connecting the condenser to the first end of the connection line and a portion of the refrigerant line connected from the second end of the connection line to the compressor may be opened. A portion of the refrigerant line connecting the evaporator to the first end of the connection line, and a portion of the refrigerant line connected from the second end of the connection line to the evaporator may be closed by the first expansion valve. The connection line may be opened by the second expansion valve, the first line may be closed by the third expansion valve, and the second line may be closed. The first expansion valve may stop operating. The second expansion valve may expand the refrigerant introduced through the connection line and may supply the expanded refrigerant to the chiller. The third expansion valve may stop operating, and the heat-exchanger may heat-exchange the refrigerant passing through the first heat-exchange device from the condenser, and the refrigerant passing through the first heat-exchange device from the chiller, with each other.

In the second heating mode, a portion of the refrigerant line connecting the compressor and the condenser may be opened. A portion of the refrigerant line connecting the condenser to a first end of the connection line and a portion of the refrigerant line connected from a second end of the connection line to the compressor may be opened. A portion of the refrigerant line connecting the evaporator to the first end of the connection line, and a portion of the refrigerant line connected from the second end of the connection line to the evaporator may be closed by the first expansion valve. The connection line may be opened by the second expansion valve. The first line may be opened by the third expansion valve. The second line may be opened, and the first expansion valve may stop operating. The second expansion valve may expand the refrigerant introduced through the connection line and may supply the expanded refrigerant to the chiller. The third expansion valve may expand the refrigerant introduced through the first line, and may supply the expanded refrigerant to the heat-exchanger through the first line. The first heat-exchange device in the heat-exchanger may heat-exchange the refrigerant passing through the first heat-exchange device from the condenser, and the refrigerant passing through the first heat-exchange device from the chiller, with each other. The second heat-exchange device in the heat-exchanger may heat-exchange the refrigerant passing through the second heat-exchange device from the condenser, and the refrigerant passing through the second heat-exchange device from the third expansion valve, with each other, and may supply the gaseous refrigerant to the compressor through the opened second line.

The second expansion valve and the third expansion valve may be 2-way electronic expansion valves configured to selectively expand the refrigerant while controlling the flow of the supplied refrigerant.

The heat pump system may further include a receiver dryer provided on the refrigerant line between the condenser and the heat-exchanger.

The heat pump system may further include, a battery module through which a first coolant circulates, and a heating device in which a second coolant circulates so as to heat the vehicle interior by using a high-temperature coolant, where the condenser is connected to the heating device through a first coolant line along which the second coolant circulates, and where the chiller is connected to the battery module through a second coolant line along which the first coolant circulates.

When heating the vehicle interior, the first coolant line may be opened to connect the condenser and the heating device.

When the battery module is to be cooled while cooling the vehicle interior, or when a waste heat of the battery module is to be recollected at the time of heating the vehicle interior, the second coolant line may be opened to connect the chiller and the battery module.

As described above, according to a heat pump system for a vehicle according to an embodiment of the present disclosure, cooling and heating performance may be improved by applying a gas injection device selectively operating in an air conditioning mode of the vehicle interior to increase the flow rate of the refrigerant.

In addition, according to the present disclosure, by using a single heat-exchanger configured to heat-exchange at least two refrigerants having different temperatures and states with each other for the entire system and the gas injection device, the total number of components may be minimized.

In addition, according to the present disclosure, the performance of the system by using the gas injection device may be maximized while minimizing the required components, and accordingly, streamlining and simplification of the system may be achieved.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram of a heat pump system for a vehicle according to an embodiment of the present disclosure.

FIG. 2 is a schematic diagram of a heat-exchanger applied to a heat pump system for a vehicle according to an embodiment of the present disclosure.

FIG. 3 is an operation diagram according to a first cooling mode of the vehicle interior in a heat pump system for a vehicle according to an embodiment of the present disclosure.

FIG. 4 is an operation diagram of a heat-exchanger according to a first cooling mode in the vehicle interior in a heat pump system for a vehicle according to an embodiment of the present disclosure.

FIG. 5 is an operation diagram according to a second cooling mode of the vehicle interior in a heat pump system for a vehicle according to an embodiment of the present disclosure.

FIG. 6 is an operation diagram of a heat-exchanger according to a second cooling mode in the vehicle interior in a heat pump system for a vehicle according to an embodiment of the present disclosure.

FIG. 7 is an operation diagram according to a first heating mode of the vehicle interior in a heat pump system for a vehicle according to an embodiment of the present disclosure.

FIG. 8 is an operation diagram of a heat-exchanger according to a first heating mode in the vehicle interior in a heat pump system for a vehicle according to an embodiment of the present disclosure.

FIG. 9 is an operation diagram according to a second heating mode of the vehicle interior in a heat pump system for a vehicle according to an embodiment of the present disclosure.

FIG. 10 is an operation diagram of heat-exchanger according to second heating mode in the vehicle interior in a heat pump system for a vehicle according to an embodiment of the present disclosure.

### DETAILED DESCRIPTION

Embodiments of the present disclosure are hereinafter described in detail with reference to the accompanying drawings.

Embodiments of the present disclosure in the present specification and the constructions depicted in the drawings are only example embodiments of the present disclosure, and may not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise” and variations such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

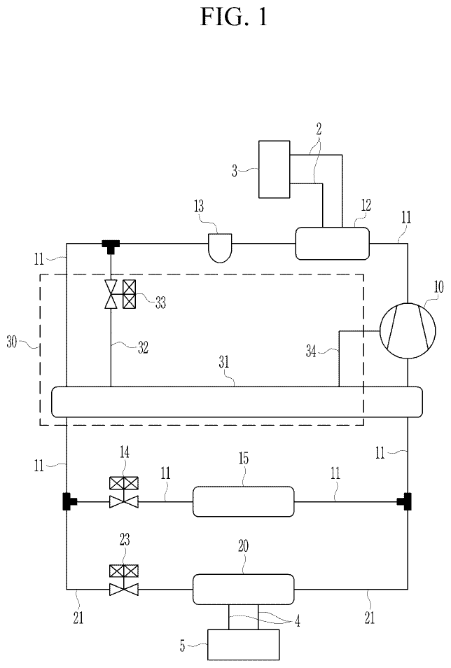

FIG. 1 is a block diagram of a heat pump system for a vehicle according to an embodiment of the present disclosure.

According to a heat pump system for the vehicle according to an embodiment of the present disclosure, by employing a gas injection device 30 selectively operating in a selected air conditioning mode of a vehicle interior among cooling, heating, or heating-and-dehumidifying of a vehicle interior to increase a flow rate of a refrigerant, the cooling and heating performance may be improved.

In addition, according to a heat pump system according to an embodiment of the present disclosure, by using a single heat-exchanger 31 configured to heat-exchange at least two refrigerants having different temperatures and states with each other for the entire system and the gas injection device 30, the total number of components may be minimized.

Referring to FIG. 1, the heat pump system may include a heating device 3 through which the coolant circulates to heat the vehicle interior by using a high-temperature coolant, and a battery module 5 through which the coolant circulates.

Such a heat pump system may further include a compressor 10, a condenser 12, a first expansion valve 14, an evaporator 15, a chiller 20, a connection line 21, a second expansion valve 23, and the gas injection device 30.

The heating device 3 may be connected to the condenser 12 through a first coolant line 2 along which the coolant circulates.

When heating the vehicle interior, the first coolant line 2 may be opened to connect the heating device 3 and the condenser 12, to supply the high-temperature coolant to the heating device 3.

Accordingly, the coolant whose temperature is increased through heat-exchange with the refrigerant in the condenser 12 may be supplied to the heating device 3 along the first coolant line 2.

The high-temperature coolant supplied to the heating device 3 may increase a temperature of ambient air passing through the heating device 3. In other words, the introduced ambient air may be converted into a high-temperature state while passing through the heating device 3 and then introduced into the vehicle interior, thereby implementing heating of the vehicle interior.

In an embodiment of the present disclosure, the battery module 5 may be connected to the chiller 20 through a second coolant line 4 along which the coolant circulates.

When the battery module 5 is to be cooled while cooling the vehicle interior, or when the waste heat of the battery module 5 is to be recollected at the time of heating the vehicle interior, the second coolant line 4 may be opened to connect the chiller 20 and the battery module 5.

A water pump (not shown) may be each provided on the first coolant line 2 and the second coolant line 4, and the coolant may be selectively circulated by an operation of each water pump.

In an embodiment of the present disclosure, the compressor 10 may compress the supplied refrigerant and allow the compressed refrigerant to flow along the refrigerant line 11 so that the refrigerant circulates along a refrigerant line 11.

The condenser 12 may be connected to the compressor 10 through the refrigerant line 11. The condenser 12 may condense the supplied refrigerant through heat-exchange with the coolant.

In other words, when heating the vehicle interior, the condenser 12 may condense the refrigerant supplied from the compressor 10 through heat-exchange with the coolant supplied from the heating device 3 through the first coolant line 2.

In an embodiment of the present disclosure, the first expansion valve 14 may be connected to the condenser 12 through the refrigerant line 11. The first expansion valve 14 may selectively expand the introduced refrigerant.

The first expansion valve 14 may be configured as one of a mechanical expansion valve configured to expand the supplied refrigerant or a 2-way electronic expansion valve configured to selectively expand the refrigerant while controlling the flow of the supplied refrigerant.

The evaporator 15 may be connected to the first expansion valve 14 through the refrigerant line 11. In addition, the evaporator 15 may be connected to the compressor 10 through the refrigerant line 11. The evaporator 15 may evaporate the refrigerant supplied from the first expansion valve 14 through heat-exchange with the ambient air.

The evaporator 15 may be provided inside a HVAC module (not shown) together with the heating device 3.

Accordingly, the ambient air passing through the evaporator 15 may be cooled while passing through the evaporator 15 by a low-temperature refrigerant supplied to the evaporator 15. The cooled ambient air may be introduced into the vehicle interior, thereby cooling the vehicle interior.

The heat pump system may further include a receiver dryer 13.

The receiver dryer 13 may be provided on the refrigerant line 11 between the condenser 12 and the first expansion valve 14. The receiver dryer 13 may be provided on the refrigerant line 11 between the condenser 12 and the heat-exchanger 31 to be described below.

The receiver dryer 13 may separate the gaseous refrigerant remaining in the liquid refrigerant condensed in the condenser 12.

In other words, the receiver dryer 13 may separate a gas component from the introduced refrigerant, and may filter moisture and foreign substances to discharge only the liquid refrigerant.

In an embodiment of the present disclosure, the chiller 20 may adjust a temperature of the coolant selectively supplied through the second coolant line 4 by heat-exchanging the refrigerant supplied from the condenser 12 with the coolant.

In other words, the chiller 20 may be a water-cooled heat-exchanger configured to heat-exchange the interiorly introduced refrigerant with the coolant.

The chiller 20 may be connected to the refrigerant line 11 through the connection line 21.

A first end of the connection line 21 may be connected to the refrigerant line 11 between the condenser 12 and the first expansion valve 14.

In addition, a second end of the connection line 21 may be connected to the refrigerant line 11 between the evaporator 15 and the compressor 10.

The chiller 20 may adjust the temperature of the coolant by heat-exchanging the coolant selectively introduced through the second coolant line 4 with the refrigerant selectively supplied from the condenser 12.

Accordingly, the coolant heat-exchanged with the refrigerant in the chiller 20 may be selectively supplied to the battery module 5, to adjust the temperature of the battery module 5.

The chiller 20 configured as such may be disposed in parallel with the evaporator 15 through the connection line 21.

In an embodiment of the present disclosure, the second expansion valve 23 may be provided on the connection line 21 at an upstream end of the chiller 20.

When the battery module 5 is to be cooled by using the coolant heat-exchanged with the refrigerant while cooling the vehicle interior, the second expansion valve 23 may expand the refrigerant introduced through the connection line 21 and allow the expanded refrigerant to flow into the chiller 20.

In other words, when the battery module 5 is to be cooled while cooling the vehicle interior, the second expansion valve 23 may expand the refrigerant introduced through the connection line 21 to lower its temperature and allow the expanded refrigerant to flow into chiller 20, and thereby may further lower temperature of the coolant passing through the interior of the chiller 20.

Accordingly, the coolant having its temperature decreased while passing through the chiller 20 may be introduced into the battery module 5, thereby achieving more efficient cooling.

When heating the vehicle interior, when the waste heat generated from the battery module 5 is to be recollected, the second expansion valve 23 may expand the refrigerant introduced through the connection line 21, and may supply the expanded refrigerant to the chiller 20.

Accordingly, the chiller 20 may evaporate the refrigerant through heat-exchange with the coolant supplied through the second coolant line 4.

The chiller 20 may recollect the waste heat of the battery module 5 while heat-exchanging the refrigerant supplied from the second expansion valve 23 with the coolant supplied from the battery module 5.

The second expansion valve 23 configured as such may be a 2-way electronic expansion valve configured to selectively expand the refrigerant while controlling the flow of the supplied refrigerant.

The upstream end of the chiller 20 may be set based on the flow direction of the refrigerant. Based on the direction in which the refrigerant flows along the connection line 21, the location where the refrigerant is introduced into the chiller 20 may be defined as an upstream end of the chiller 20, and the location where the refrigerant is discharged from the chiller 20 may be defined as a downstream end of the chiller 20.

An embodiment of the present disclosure takes an example in which the chiller 20 is connected to the battery module 5 through the second coolant line 4, but is not limited thereto, and the chiller 20 may be connected to an electrical component (not shown) through a separate coolant line.

In an embodiment of the present disclosure, the heat-exchanger 31 may be included in the gas injection device 30. The heat-exchanger 31 may be respectively connected to the refrigerant line 11 connecting the condenser 12 and the first expansion valve 14, and the refrigerant line 11 connecting the evaporator 15 and the compressor 10.

In other words, the heat-exchanger 31 may heat-exchange the refrigerant supplied from the condenser 12, and the refrigerant supplied from at least one of the evaporator 15 or the chiller 20, with each other.

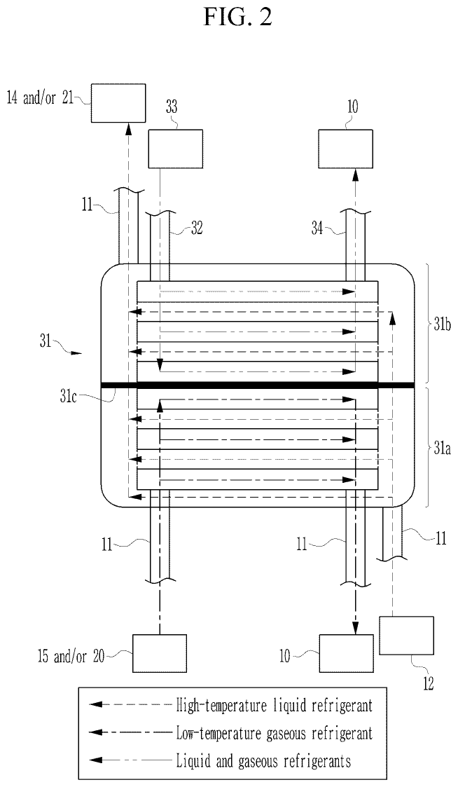

A detailed structure of the heat-exchanger 31 configured as such is described in detail with reference to FIG. 2.

In addition, the gas injection device 30 may include the heat-exchanger 31, and may be provided on the refrigerant line 11 between the condenser 12 and the first expansion valve 14.

The gas injection device 30 may expand the refrigerant selectively introduced from the condenser 12 and supply the expanded refrigerant to the heat-exchanger 31, and may supply the refrigerant heat-exchanged in the heat-exchanger 31 to the compressor 10, so as to increase the flow rate of the refrigerant circulating the refrigerant line 11.

The gas injection device 30 configured as such may be selectively operated at the time of cooling or heating the vehicle interior.

The gas injection device 30 may further include a first line 32, a third expansion valve 33, and a second line 34.

A first end of the first line 32 may be connected to the refrigerant line 11 between the condenser 12 and the heat-exchanger 31. A second end of the first line 32 may be connected to the heat-exchanger 31.

In an embodiment of the present disclosure, the third expansion valve 33 may be provided on the first line 32. The third expansion valve 33 may selectively expand the introduced refrigerant.

When an operation of the gas injection device 30 is required, the third expansion valve 33 may expand the refrigerant supplied from the condenser 12 through the first line 32, and may supply the expanded refrigerant to the heat-exchanger 31.

The third expansion valve 33 configured as such may be a 3-way electronic expansion valve configured to selectively expand the refrigerant while controlling the flow of the refrigerant.

In addition, a first end of the second line 34 may be connected to the heat-exchanger 31. A second end of the second line 34 may be connected to the compressor 10.

When the expanded refrigerant is supplied to the heat-exchanger 31, the second line 34 may supply the gaseous refrigerant from the heat-exchanger 31 to the compressor 10.

In other words, the second line 34 may connect the heat-exchanger 31 and the compressor 10 so that the refrigerant vaporized through heat-exchange in the heat-exchanger 31 is selectively introduced into the compressor 10.

In the gas injection device 30 configured as such, the heat-exchanger 31 may heat-exchange the refrigerant discharged from the condenser 12, and the refrigerant expanded in the third expansion valve 33, with each other.

When the refrigerant expanded in the third expansion valve 33 is supplied to the heat-exchanger 31 through the first line 32, the heat-exchanger 31 may vaporize the refrigerant supplied from the third expansion valve 33 through heat-exchange with the refrigerant supplied from the condenser 12.

The refrigerant vaporized in the heat-exchanger 31 may be supplied to the compressor 10 through the second line 34.

In summary, the heat-exchanger 31 may vaporize the expanded refrigerant through heat-exchange with the refrigerant supplied from the condenser 12, and may supply the vaporized refrigerant to the compressor 10 through the second line 34 to increase the flow rate of the refrigerant circulating the refrigerant line 11.

In other words, the heat-exchanger 31 may heat-exchange the refrigerant supplied from the condenser 12, and the refrigerant supplied from at least one of the evaporator 15 or the chiller 20, with each other.

In addition, the heat-exchanger 31 may heat-exchange the refrigerant supplied from the condenser 12, and the expanded refrigerant supplied from the third expansion valve 33, with each other, by the operation of the gas injection device 30.

A detailed structure and connection structure of the heat-exchanger 31 are described in detail hereinbelow with reference to FIG. 2.

FIG. 2 is a schematic diagram of a heat-exchanger applied to a heat pump system for a vehicle according to an embodiment of the present disclosure.

Referring to FIG. 2, the heat-exchanger 31 may include a first heat-exchange device 31a, a second heat-exchange device 31b, and a barrier rib 31c.

To increase the condensation degree through sub-cooling increase of the refrigerant, the first heat-exchange device 31a may heat-exchange the refrigerant (a high-temperature liquid refrigerant) supplied from the condenser 12 through the refrigerant line 11, and the refrigerant (low-temperature gaseous refrigerant) supplied from one or all of the evaporator 15 or the chiller 20, with each other.

Within the first heat-exchange device 31a, a plurality of plates may be stacked so as to alternately form fluid lines through which the refrigerant flows respectively. Accordingly, respective refrigerants may be heat-exchanged with each other while passing through different fluid lines.

Respective refrigerants may flow in opposite directions to each other in an interior of the first heat-exchange device 31a.

In other words, the first heat-exchange device 31a may heat-exchange the high-temperature liquid refrigerant introduced from the condenser 12, and the low-temperature gaseous refrigerant supplied from one or all of the evaporator 15 or the chiller 20, with each other, by causing them to flow in a counterflow arrangement.

Accordingly, the first heat-exchange device 31a may additionally heat-exchange the low-temperature refrigerant with a high-temperature refrigerant to further lower the temperature of the refrigerant and increase the condensation degree.

As such, the first heat-exchange device 31a may further condense the refrigerant condensed in the condenser 12, thereby increasing the sub-cooling of the refrigerant, and accordingly, the coefficient of performance (COP), which is a coefficient of cooling capability compared to a required compressor power, may be improved.

In an embodiment of the present disclosure, the second heat-exchange device 31b may heat-exchange the refrigerant (the high-temperature liquid refrigerant) supplied from the condenser 12 through the refrigerant line 11, and the refrigerant (intermediate-temperature liquid and gaseous refrigerants) expanded in the third expansion valve 33 and supplied through the first line 32, with each other.

The plurality of plates are stacked in the second heat-exchange device 31b, so that fluid lines along which the high-temperature refrigerant and the intermediate-temperature refrigerant flow may be internally formed alternately. Accordingly, the high-temperature refrigerant and the intermediate-temperature refrigerant may be heat-exchanged with each other while passing through different fluid lines.

The high-temperature refrigerant and the intermediate-temperature refrigerant may flow in opposite directions to each other in an interior of the second heat-exchange device 31b.

In other words, the second heat-exchange device 31b may heat-exchange the high-temperature liquid refrigerant introduced from the condenser 12, and the intermediate-temperature double-phase refrigerant (the refrigerant including both liquid and gas) expanded in and supplied from the third expansion valve 33, with each other, by causing them to flow in a counterflow arrangement.

Accordingly, when the gas injection device 30 is operated, the second heat-exchange device 31b may vaporize the intermediate-temperature two-phase refrigerant through heat-exchange with the high-temperature liquid refrigerant, and may supply the vaporized gaseous refrigerant to the compressor 10 through the second line 34.

In addition, the barrier rib 31c may partition the first heat-exchange device 31a and the second heat-exchange device 31b.

The barrier rib 31c may allow the refrigerant supplied from the condenser 12 to flow to the first heat-exchange device 31a and the second heat-exchange device 31b so that the refrigerant (the high-temperature liquid refrigerant) supplied from the condenser 12 through the refrigerant line 11 flow together in the first heat-exchange device 31a and the second heat-exchange device 31b.

In addition, the barrier rib 31c may prevent the refrigerant supplied from at least one of the evaporator 15 or the chiller 20 to the first heat-exchange device 31a through the refrigerant line 11 from being mixed with the refrigerant supplied from the third expansion valve 33 to the second heat-exchange device 31b through the first line 32.

The heat-exchanger 31 configured as such may be a plate-type heat-exchanger in which a plurality of plates are stacked to form the first heat-exchange device 31a and the second heat-exchange device 31b.

In an embodiment of the present disclosure, in the heat pump system, the flow of the refrigerant may be controlled through an operation control of the gas injection device 30, depending on at least one mode for adjusting a temperature of a vehicle interior.

The at least one mode may include a first cooling mode, a second cooling mode, a first heating mode, and a second heating mode.

In the first cooling mode, the gas injection device 30 may not be operated, and the vehicle interior may be cooled.

In the second cooling mode, the gas injection device 30 may be operated, and the vehicle interior may be cooled.

In the first cooling mode and the second cooling mode, the battery module 5 may be selectively cooled.

In an embodiment of the present disclosure, in the first heating mode, the gas injection device 30 may not be operated, and the vehicle interior may be heated.

In addition, in the second heating mode, the gas injection device 30 may be operated, and the vehicle interior may be heated.

Hereinafter, an operation and action of a heat pump system for the vehicle according to an embodiment of the present disclosure configured as described above are described in detail with reference to FIGS. 2-7.

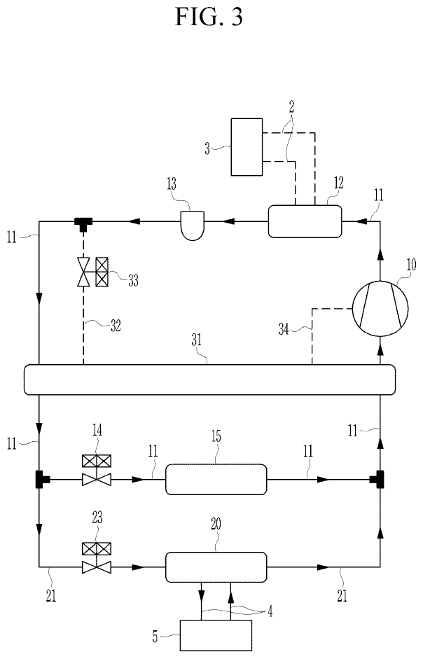

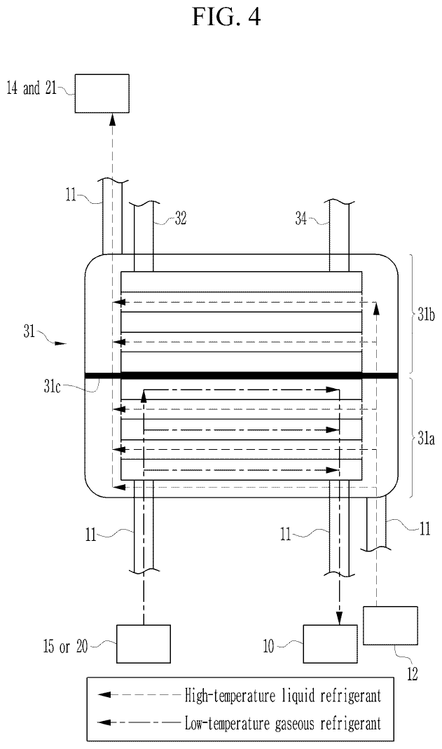

An operation in the first cooling mode, which is for cooling the battery module 5 while cooling the vehicle interior, and in which the gas injection device 30 is not operated with the refrigerant discharged from the heat-exchanger 31, is described in detail with reference to FIG. 3 and FIG. 4.

FIG. 3 is an operation diagram according to the first cooling mode in a heat pump system for the vehicle according to an embodiment of the present disclosure, and FIG. 4 is an operation diagram of a heat-exchanger according to a first cooling mode in the vehicle interior in a heat pump system for the vehicle according to an embodiment of the present disclosure.

Referring to FIG. 3, in the first cooling mode, the refrigerant line 11 interconnecting the compressor 10, the condenser 12, the first expansion valve 14, and the evaporator 15 may be opened.

The first line 32 may be closed by the third expansion valve 33. In addition, the second line 34 may be closed. The operation of the third expansion valve 33 may be stopped.

In such a state, the refrigerant compressed in the compressor 10 may be introduced into the condenser 12 along the refrigerant line 11. The first coolant line 2 may be closed so that the coolant is not supplied to the heating device 3.

The condenser 12 may condense the refrigerant by using the coolant supplied from a radiator (not shown) and an electrical component.

The refrigerant having passed through the condenser 12 may be introduced into the receiver dryer 13 along the refrigerant line 11. The receiver dryer 13 may separate a gas component from the introduced refrigerant, and may filter moisture and foreign substances to discharge only the liquid refrigerant.

The refrigerant discharged from the receiver dryer 13 may be supplied to the heat-exchanger 31 along the refrigerant line 11.

The refrigerant having passed through the heat-exchanger 31 may be introduced into the first expansion valve 14 along the refrigerant line 11.

The first expansion valve 14 may expand the refrigerant introduced through the refrigerant line 11 and supply the expanded refrigerant to the evaporator 15.

In such a state, the ambient air introduced into a HVAC module (not shown) may be cooled by the low-temperature refrigerant introduced into the evaporator 15 while passing through the evaporator 15. The cooled ambient air may cool the vehicle interior by being directly introduced into the vehicle interior.

In addition, the refrigerant having passed through the evaporator 15 may be introduced into the heat-exchanger 31 along the refrigerant line 11. Thereafter, the refrigerant may pass through the heat-exchanger 31, to be introduced into the compressor 10.

When cooling of the battery module 5 is required in the first cooling mode, the connection line 21 may be opened by the second expansion valve 23.

A partial refrigerant among the refrigerant having passed through the heat-exchanger 31 from the condenser 12 may be introduced into the first expansion valve 14 along the refrigerant line 11.

In addition, a remaining refrigerant among the refrigerant having passed through the heat-exchanger 31 from the condenser 12 may be introduced into the second expansion valve 23.

In other words, the refrigerant discharged from the heat-exchanger 31 may be respectively introduced into the first expansion valve 14 and the second expansion valve 23 along the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the battery module 5 through the second coolant line 4.

The coolant cooled in the chiller 20 may be supplied to the battery module 5 along the second coolant line 4. Accordingly, the battery module 5 may be efficiently cooled by the coolant cooled in the chiller 20.

In other words, the coolant circulating through the second coolant line 4 may efficiently cool the battery module 5 while repeatedly performing the above-described operation.

The refrigerant having passed through the chiller 20 may be introduced into the heat-exchanger 31 together with the refrigerant discharged from the evaporator 15. Thereafter, the refrigerant may pass through the heat-exchanger 31, to be introduced into the compressor 10.

As shown in FIG. 4, the heat-exchanger 31 may heat-exchange the refrigerant (the high-temperature liquid refrigerant) passing through the first heat-exchange device 31a from the condenser 12, and the refrigerant (low-temperature gaseous refrigerant) passing through the first heat-exchange device 31a from the evaporator 15 and the chiller 20, with each other.

Accordingly, the refrigerant discharged from the condenser 12 may be additionally condensed in the heat-exchanger 31 through heat-exchange with the refrigerant supplied from the evaporator 15 and the chiller 20.

In other words, the heat-exchanger 31 may be operated to increase the condensation degree through sub-cooling increase of the refrigerant, as described above.

Accordingly, the heat-exchanger 31 may subcool the refrigerant condensed in the condenser 12 and supply the subcooled refrigerant to the evaporator 15, to have the enthalpy difference of the evaporator 15 to be significantly large, thereby minimizing the cooling load.

Through such an operation, the heat pump system can maximize the coefficient of performance (COP), which is a coefficient of cooling capability compared to a required compressor power, and accordingly, the overall cooling performance and cooling efficiency may be improved compared to the conventional scheme.

The refrigerant compressed in the compressor 10 may pass through the condenser 12, to be then supplied to the heat-exchanger 31 along the refrigerant line 11.

The heat pump system may repeatedly perform the above-described processes.

While repeatedly performing the above-described operation, the heat pump system may cool the vehicle interior more efficiently, and may improve the overall cooling performance and efficiency.

The heat pump system may efficiently cool the battery module 5 by using a low-temperature coolant cooled in the chiller 20.

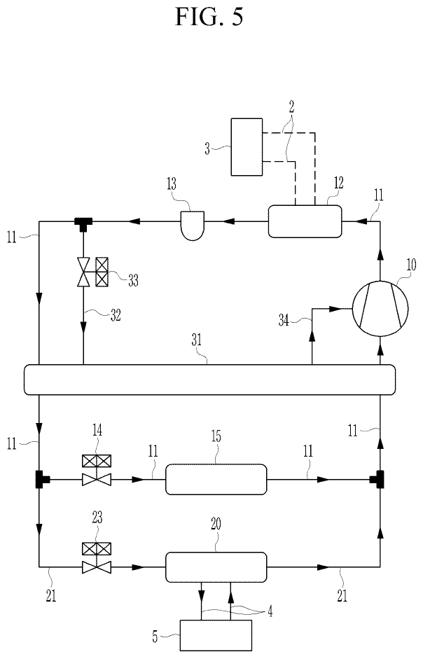

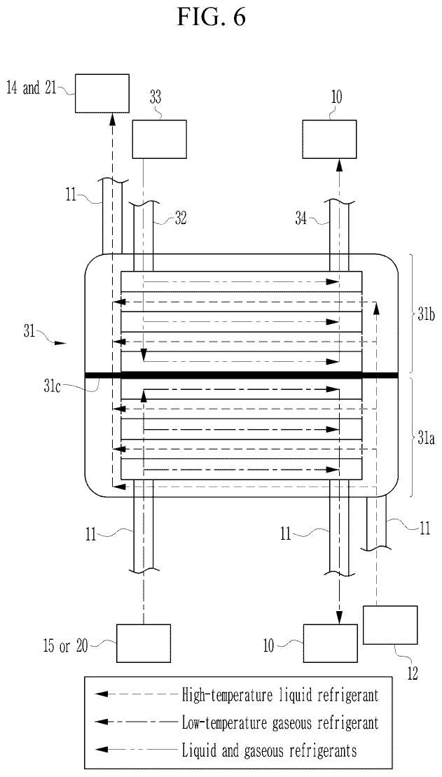

In an embodiment of the present disclosure, an operation in the second cooling mode for cooling the vehicle interior and in which the gas injection device 30 is operated is described in detail with reference to FIG. 5 and FIG. 6.

FIG. 5 is an operation diagram according to the second cooling mode of the vehicle interior in a heat pump system for the vehicle according to an embodiment of the present disclosure, and FIG. 6 is an operation diagram of a heat-exchanger according to a second cooling mode in the vehicle interior in a heat pump system for the vehicle according to an embodiment of the present disclosure.

Referring to FIG. 5, in the second cooling mode, the refrigerant line 11 interconnecting the compressor 10, the condenser 12, the first expansion valve 14, and the evaporator 15 may be opened.

The first line 32 may be opened by the third expansion valve 33. In addition, the second line 34 may be opened.

In such a state, the refrigerant compressed in the compressor 10 may be introduced into the condenser 12 along the refrigerant line 11. The first coolant line 2 may be closed so that the coolant is not supplied to the heating device 3.

The condenser 12 may condense the refrigerant by using the coolant supplied from a radiator (not shown) and electrical component.

The refrigerant having passed through the condenser 12 may be introduced into the receiver dryer 13 along the refrigerant line 11. The receiver dryer 13 may separate a gas component from the introduced refrigerant, and may filter moisture and foreign substances to discharge only the liquid refrigerant.

A partial refrigerant among the refrigerant discharged from the receiver dryer 13 may be introduced into the first line 32.

The third expansion valve 33 may expand the refrigerant introduced through the first line 32, and may supply the expanded refrigerant to the heat-exchanger 31 through the first line 32.

A remaining refrigerant among the refrigerant discharged from the receiver dryer 13 may be supplied to the heat-exchanger 31 along the refrigerant line 11.

The heat-exchanger 31 may heat-exchange the refrigerant introduced from the third expansion valve 33 into the first line 32 (intermediate-temperature liquid and gaseous refrigerants), and the refrigerant supplied from the condenser 12 (the high-temperature liquid refrigerant), with each other.

Accordingly, the heat-exchanger 31 may vaporize the refrigerant supplied from the third expansion valve 33 through heat-exchange with the refrigerant supplied from the condenser 12, and may supply the vaporized gaseous refrigerant to the compressor 10 through the second line 34.

Through such an operation, the gas injection device 30 may return the gaseous refrigerant discharged from the heat-exchanger 31 back to the compressor 10 through the second line 34, thereby increasing the flow rate of the refrigerant circulating the refrigerant line 11.

The refrigerant introduced from the condenser 12 into the heat-exchanger 31 may be additionally condensed through heat-exchange with the refrigerant supplied through the first line 32.

The refrigerant additionally condensed in the heat-exchanger 31 may be introduced into the first expansion valve 14 along the refrigerant line 11.

The first expansion valve 14 may expand the refrigerant introduced through the refrigerant line 11 and supply the expanded refrigerant to the evaporator 15.

In such a state, the ambient air introduced into a HVAC module (not shown) may be cooled by the low-temperature refrigerant introduced into the evaporator 15 while passing through the evaporator 15. The cooled ambient air may cool the vehicle interior by being directly introduced into the vehicle interior.

In addition, the refrigerant having passed through the evaporator 15 may be introduced into the heat-exchanger 31 along the refrigerant line 11. Thereafter, the refrigerant may pass through the heat-exchanger 31, to be introduced into the compressor 10.

When cooling of the battery module 5 is required in the second cooling mode, the connection line 21 may be opened by the second expansion valve 23.

A partial refrigerant among the refrigerant having passed through the heat-exchanger 31 from the condenser 12 may be introduced into the first expansion valve 14 along the refrigerant line 11.

In addition, a remaining refrigerant among the refrigerant having passed through the heat-exchanger 31 from the condenser 12 may be introduced into the second expansion valve 23.

In other words, the refrigerant discharged from the heat-exchanger 31 may be respectively introduced into the first expansion valve 14 and the second expansion valve 23 along the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the battery module 5 through the second coolant line 4.

The coolant cooled in the chiller 20 may be supplied to the battery module 5 along the second coolant line 4. Accordingly, the battery module 5 may be efficiently cooled by the coolant cooled in the chiller 20.

In other words, the coolant circulating through the second coolant line 4 may efficiently cool the battery module 5 while repeatedly performing the above-described operation.

The refrigerant having passed through the chiller 20 may be introduced into the heat-exchanger 31 together with the refrigerant discharged from the evaporator 15. Thereafter, the refrigerant may pass through the heat-exchanger 31, to be introduced into the compressor 10.

As shown in FIG. 6, the heat-exchanger 31 may heat-exchange the refrigerant passing through the second heat-exchange device 31b from the condenser 12, and the refrigerant passing through the second heat-exchange device 31b from the third expansion valve 33, with each other.

In other words, the second heat-exchange device 31b may vaporize the refrigerant supplied from the third expansion valve 33 through heat-exchange with the refrigerant supplied from the condenser 12, and may supply the vaporized gaseous refrigerant to the compressor 10 through the second line 34.

The refrigerant passing through the second heat-exchange device 31b from the condenser 12 may be additionally condensed through heat-exchange with the refrigerant supplied through the first line 32.

The heat-exchanger 31 may heat-exchange the refrigerant (the high-temperature liquid refrigerant) passing through the first heat-exchange device 31a from the condenser 12, and the refrigerant (low-temperature gaseous refrigerant) passing through the first heat-exchange device 31a from the evaporator 15 and the chiller 20, with each other.

Accordingly, the refrigerant discharged from the condenser 12 may be additionally condensed in the heat-exchanger 31 through heat-exchange with the refrigerant supplied from the evaporator 15 and the chiller 20.

The refrigerant introduced from the condenser 12 into the heat-exchanger 31 may increase its condensation degree while being additionally condensed in the first and second heat-exchange devices 31a and 31b, respectively.

In other words, the heat-exchanger 31 may be operated to increase the condensation degree through sub-cooling increase of the refrigerant, as described above.

Accordingly, the heat-exchanger 31 may subcool the refrigerant condensed in the condenser 12 and supply the subcooled refrigerant to the evaporator 15, and thereby the enthalpy difference of the evaporator 15 may be significantly large.

Through such an operation, the heat pump system can maximize the coefficient of performance (COP), which is a coefficient of cooling capability compared to a required compressor power, and accordingly, the overall cooling performance and cooling efficiency may be improved compared to the conventional scheme.

The refrigerant compressed in the compressor 10 may pass through the condenser 12, to be then supplied to the heat-exchanger 31 along the refrigerant line 11.

The heat pump system may repeatedly perform the above-described processes.

In other words, while repeatedly performing the above-described operation, the heat pump system may increase the flow rate of the refrigerant flowing along the refrigerant line 11.

In addition, the heat-exchanger 31 may heat-exchange the refrigerant introduced from the condenser 12, and the refrigerant supplied from the evaporator 15 and the chiller 20, with each other, and additionally heat-exchange it with the refrigerant supplied from the third expansion valve 33, thereby further increasing the condensation degree of the refrigerant.

In addition, the gas injection device 30 may control the flow of the refrigerant, and may increase the condensation degree of the refrigerant by using the heat-exchanger 31, to increase a subcooling degree of the refrigerant discharged from the condenser 12.

When the subcooling degree of the refrigerant discharged from the condenser 12 is increased, the enthalpy difference may be increased to be significantly large in the evaporator 15, thereby minimizing the cooling load.

In addition, the heat pump system may increase the flow rate of the refrigerant flowing along the refrigerant line 11, thereby improving the overall cooling performance and efficiency.

The heat pump system may efficiently cool the battery module 5 by using the low-temperature coolant cooled in the chiller 20.

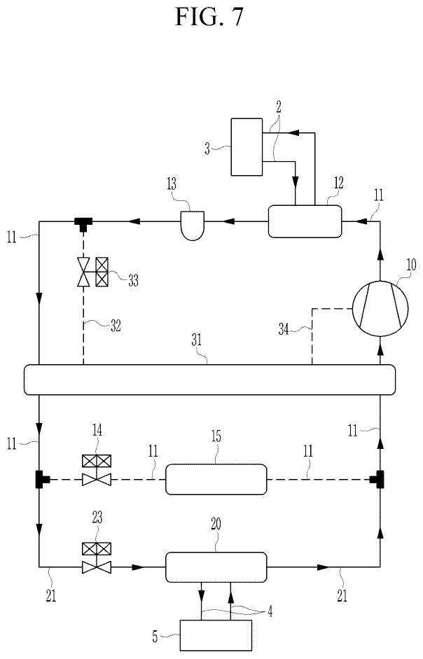

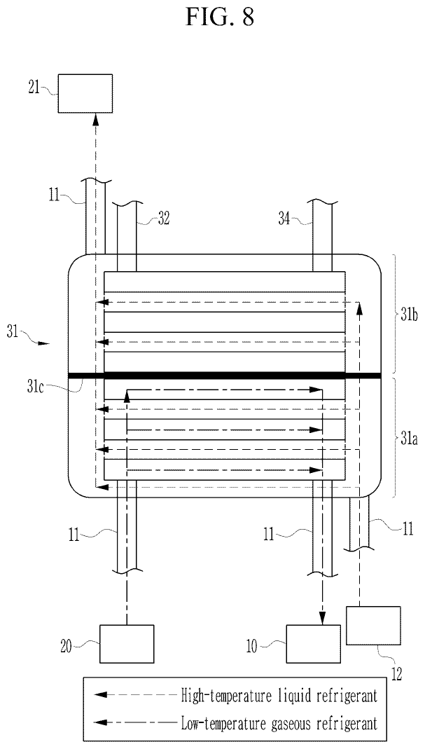

In an embodiment of the present disclosure, an operation in the first heating mode, which is for heating the vehicle interior, and in which the gas injection device 30 is not operated, is described in detail with reference to FIG. 7 and FIG. 8.

FIG. 7 is an operation diagram according to the first heating mode of the vehicle interior in a heat pump system for the vehicle according to an embodiment of the present disclosure, and FIG. 8 is an operation diagram of a heat-exchanger according to a first heating mode in the vehicle interior in a heat pump system for the vehicle according to an embodiment of the present disclosure.

Referring to FIG. 7, in the first heating mode, a portion of the refrigerant line 11 connecting the compressor 10 and the condenser 12 may be opened.

The portion of the refrigerant line 11 connecting the condenser 12 to the first end of the connection line 21 and the portion of the refrigerant line 11 connecting the second end of the connection line 21 to the compressor 10 may be opened.

The portion of the refrigerant line 11 connecting the evaporator 15 to the first end of the connection line 21 and the portion of the refrigerant line 11 connecting the second end of the connection line 21 to the evaporator 15 may be closed by the first expansion valve 14.

The connection line 21 may be opened by the second expansion valve 23.

Operation of the first expansion valve 14 may be stopped. Accordingly, the refrigerant may not be supplied to the evaporator 15.

The first line 32 may be closed by the third expansion valve 33. In addition, the second line 34 may be closed. The operation of the third expansion valve 33 may be stopped.

In such a state, the refrigerant compressed in the compressor 10 may be introduced into the condenser 12 along the refrigerant line 11. The first coolant line 2 may be opened so that coolant is supplied to the heating device 3.

Accordingly, the refrigerant introduced into the condenser 12 may be condensed while being heat-exchanged with the coolant supplied from the heating device 3 through the first coolant line 2. The coolant whose temperature is increased through heat-exchange with the refrigerant in the condenser 12 may be supplied to the heating device 3.

The refrigerant having passed through the condenser 12 may be introduced into the receiver dryer 13 along the refrigerant line 11. The receiver dryer 13 may separate a gas component from the introduced refrigerant, and may filter moisture and foreign substances to discharge only the liquid refrigerant.

The refrigerant discharged from the receiver dryer 13 may be supplied to the heat-exchanger 31 along the refrigerant line 11.

The refrigerant having passed through the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the battery module 5 through the second coolant line 4.

The coolant may increase its temperature by recollecting the waste heat from the battery module 5 while cooling the battery module 5. The coolant whose temperature is increased through such an operation may be supplied to the chiller 20.

The chiller 20 may recollect the waste heat of the battery module 5 while exchanging heat between the coolant supplied from the battery module 5 through the second coolant line 4 and the refrigerant.

In addition, the refrigerant having passed through the chiller 20 may be introduced into the heat-exchanger 31 along the connection line 21 and the opened refrigerant line 11. Thereafter, the refrigerant may pass through the heat-exchanger 31, to be introduced into the compressor 10.

As shown in FIG. 8, the heat-exchanger 31 may heat-exchange the refrigerant (the high-temperature liquid refrigerant) passing through the first heat-exchange device 31a from the condenser 12, and the refrigerant (low-temperature gaseous refrigerant) passing through the first heat-exchange device 31a from the chiller 20, with each other.

Accordingly, the refrigerant discharged from the condenser 12 may be additionally condensed in the heat-exchanger 31 through heat-exchange with the refrigerant supplied from the chiller 20.

In other words, the heat-exchanger 31 may additionally condense the refrigerant condensed in the condenser 12, so as to increase the condensation degree of the refrigerant.

The refrigerant whose condensation degree has been increased may be supplied to the chiller 20 after having been expanded the second expansion valve 23, and may efficiently recollect the waste heat of the battery module 5 while being heat-exchanged with the coolant supplied from the battery module 5 in the chiller 20.

The refrigerant compressed in the compressor 10 may pass through the condenser 12, to be then supplied to the heat-exchanger 31 along the refrigerant line 11.

Then, the heat pump system may repeatedly perform the above-described processes.

The ambient air introduced into the vehicle interior may be converted into a high-temperature state through heat-exchange with the high-temperature coolant introduced into the heating device 3 and introduced into the vehicle interior, thereby achieving heating of the vehicle interior.

Accordingly, the refrigerant circulating in the heat pump system can smoothly recollect the waste heat from the coolant whose temperature is increased while passing through the battery module 5, in the chiller 20, thereby improving the overall heating performance and efficiency.

In addition, according to the present disclosure, the heating efficiency and performance may be improved while minimizing the usage of a separate electric heater.

In addition, the heat-exchanger 31 may heat-exchange the refrigerant supplied from the chiller 20, and the refrigerant condensed in the condenser 12, with each other, to additionally condense the condensed refrigerant, and allow the additionally condensed refrigerant to flow, thereby increasing the subcooling degree of the refrigerant discharged from the condenser 12.

While the waste heat generated from the battery module 5 or an electrical component (not shown) is not sufficient, when the subcooling degree of the refrigerant discharged from the condenser 12 is increased, the enthalpy difference in the chiller 20 may be increased to be significantly large, and accordingly, the waste heat can be recollected more smoothly and used for heating the vehicle interior.

As such, since the heat pump system can sufficiently recollect and use the waste heat, the heating performance and efficiency can be improved.

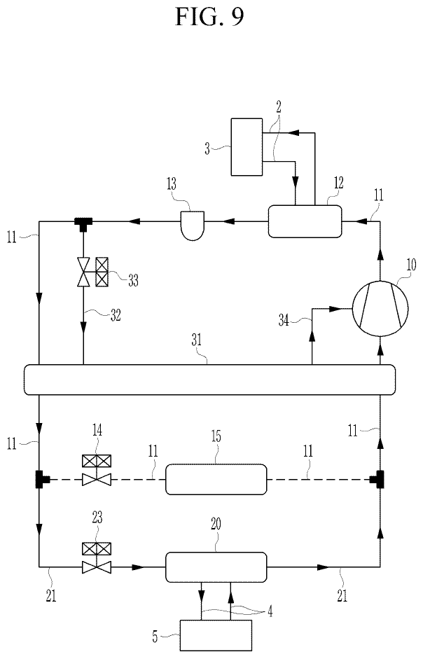

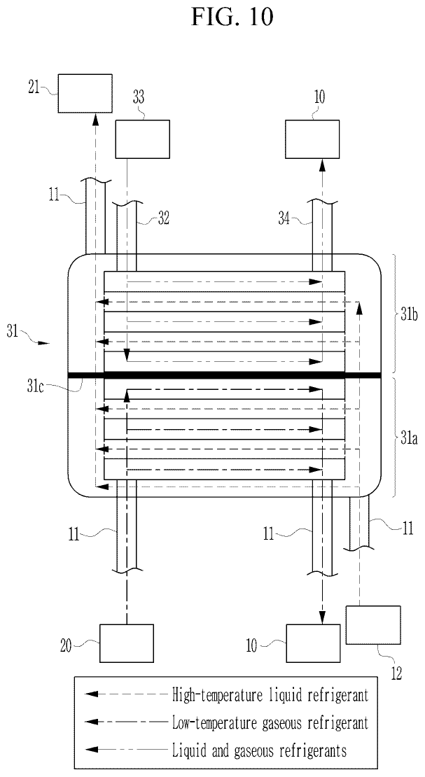

In an embodiment of the present disclosure, an operation in the second heating mode for heating the vehicle interior and in which the gas injection device 30 is operated by the refrigerant discharged from the condenser 12 is described in detail below with reference to FIG. 9 and FIG. 10.

FIG. 9 is an operation diagram according to the second heating mode of the vehicle interior in a heat pump system for the vehicle according to an embodiment of the present disclosure, and FIG. 10 is an operation diagram of a heat-exchanger according to a second heating mode in the vehicle interior in a heat pump system for the vehicle according to an embodiment of the present disclosure.

Referring to FIG. 9, in the second heating mode, the portion of the refrigerant line 11 connecting the compressor 10 and the condenser 12 may be opened.

The portion of the refrigerant line 11 connecting the condenser 12 to the first end of the connection line 21 and the portion of the refrigerant line 11 connecting the second end of the connection line 21 to the compressor 10 may be opened.

The portion of the refrigerant line 11 connecting the evaporator 15 to the first end of the connection line 21 and the portion of the refrigerant line 11 connecting the second end of the connection line 21 to the evaporator 15 may be closed by the first expansion valve 14.

The connection line 21 may be opened by the second expansion valve 23.

Operation of the first expansion valve 14 may be stopped. Accordingly, the refrigerant may not be supplied to the evaporator 15.

The first line 32 may be opened by the third expansion valve 33. In addition, the second line 34 may be opened.

In such a state, the refrigerant compressed in the compressor 10 may be introduced into the condenser 12 along the refrigerant line 11. The first coolant line 2 may be opened so that coolant is the supplied to the heating device 3.

Accordingly, the refrigerant introduced into the condenser 12 may be condensed while being heat-exchanged with the coolant supplied from the heating device 3 through the first coolant line 2. The coolant whose temperature is increased through heat-exchange with the refrigerant in the condenser 12 may be supplied to the heating device 3.

The refrigerant having passed through the condenser 12 may be introduced into the receiver dryer 13 along the refrigerant line 11. The receiver dryer 13 may separate a gas component from the introduced refrigerant, and may filter moisture and foreign substances to discharge only the liquid refrigerant.

A partial refrigerant among the refrigerant discharged from the receiver dryer 13 may be introduced into the first line 32.

The third expansion valve 33 may expand the refrigerant introduced through the first line 32, and may supply the expanded refrigerant to the heat-exchanger 31 through the first line 32.

A remaining refrigerant among the refrigerant discharged from the receiver dryer 13 may be supplied to the heat-exchanger 31 along the refrigerant line 11.

The heat-exchanger 31 may heat-exchange the refrigerant introduced from the third expansion valve 33 into the first line 32 (intermediate-temperature liquid and gaseous refrigerants), and the refrigerant supplied from the condenser 12 (the high-temperature liquid refrigerant), with each other.

Accordingly, the heat-exchanger 31 may vaporize the refrigerant supplied from the third expansion valve 33 through heat-exchange with the refrigerant supplied from the condenser 12, and may supply the vaporized gaseous refrigerant to the compressor 10 through the second line 34.

Through such an operation, the gas injection device 30 may return the gaseous refrigerant discharged from the heat-exchanger 31 back to the compressor 10 through the second line 34, thereby increasing the flow rate of the refrigerant circulating the refrigerant line 11.

The refrigerant introduced from the condenser 12 into the heat-exchanger 31 may be additionally condensed through heat-exchange with the refrigerant supplied through the first line 32.

The refrigerant additionally condensed in the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while being heat-exchanged with the coolant supplied from the battery module 5 through the second coolant line 4.

The coolant may increase its temperature by recollecting the waste heat from the battery module 5 while cooling the battery module 5. The coolant whose temperature is increased through such an operation may be supplied to the chiller 20.

The chiller 20 may recollect the waste heat of the battery module 5 while exchanging heat between the coolant supplied from the battery module 5 through the second coolant line 4 with the refrigerant.

In addition, the refrigerant having passed through the chiller 20 may be introduced into the heat-exchanger 31 along the connection line 21 and the opened refrigerant line 11. Thereafter, the refrigerant may pass through the heat-exchanger 31, to be introduced into the compressor 10.

As shown in FIG. 10, the heat-exchanger 31 may heat-exchange the refrigerant passing through the second heat-exchange device 31b from the condenser 12, and the refrigerant passing through the second heat-exchange device 31b from the third expansion valve 33, with each other.

In other words, the second heat-exchange device 31b may vaporize the refrigerant supplied from the third expansion valve 33 through heat-exchange with the refrigerant supplied from the condenser 12, and may supply the vaporized gaseous refrigerant to the compressor 10 through the second line 34.

The refrigerant passing through the second heat-exchange device 31b from the condenser 12 may be additionally condensed through heat-exchange with the refrigerant supplied through the first line 32.

The heat-exchanger 31 may heat-exchange the refrigerant (the high-temperature liquid refrigerant) passing through the first heat-exchange device 31a from the condenser 12, and the refrigerant (low-temperature gaseous refrigerant) passing through the first heat-exchange device 31a from the chiller 20, with each other.

Accordingly, the refrigerant discharged from the condenser 12 may be additionally condensed in the heat-exchanger 31 through heat-exchange with the refrigerant supplied from the chiller 20.

The refrigerant introduced from the condenser 12 into the heat-exchanger 31 may be additionally condensed in the first and second heat-exchange devices 31a and 31b, thereby increasing the condensation degree.

The refrigerant whose condensation degree has been increased may be supplied to the chiller 20 after having been expanded by the second expansion valve 23, and may efficiently recollect the waste heat of the battery module 5 while being heat-exchanged with the coolant supplied from the battery module 5 in the chiller 20.

The refrigerant compressed in the compressor 10 may pass through the condenser 12, to be then supplied to the heat-exchanger 31 along the refrigerant line 11.

The heat pump system may repeatedly perform the above-described processes.

The ambient air introduced into the vehicle interior may be converted into a high-temperature state through heat-exchange with the high-temperature coolant introduced into the heating device 3 and introduced into the vehicle interior, thereby achieving heating of the vehicle interior.

Accordingly, the refrigerant circulating in the heat pump system can smoothly recollect the waste heat from the coolant whose temperature is increased while passing through the battery module 5, in the chiller 20, thereby improving the overall heating performance and efficiency.

In addition, according to the present disclosure, the heating efficiency and performance may be improved while minimizing the usage of a separate electric heater.

In other words, while repeatedly performing the above-described operation, the heat pump system may increase the flow rate of the refrigerant flowing along the refrigerant line 11, thereby maximizing the heating performance.

In addition, the heat-exchanger 31 may heat-exchange the refrigerant introduced from the condenser 12, and the refrigerant supplied from the chiller 20, with each other, and additionally heat-exchange it with the refrigerant supplied from the third expansion valve 33, thereby further increasing the condensation degree of the refrigerant.

In addition, the gas injection device 30 may control the flow of the refrigerant and increase the condensation degree of the refrigerant by using the heat-exchanger 31, thereby increasing the subcooling degree of the refrigerant discharged from the condenser 12.

While the waste heat generated from the battery module 5 or an electrical component (not shown) is sufficient, when the subcooling degree of the refrigerant discharged from the condenser 12 is increased, the enthalpy difference in the chiller 20 may be increased to be significantly large, and accordingly, the waste heat can be recollected more smoothly and used for heating the vehicle interior.

As such, since the heat pump system can sufficiently recollect and use the waste heat, the heating performance and efficiency can be improved.

As described above, according to a heat pump system for the vehicle according to an embodiment of the present disclosure, by using the single chiller 20 where the coolant and the refrigerant are heat-exchanged with each other, the waste heat of the battery module 5 may be recollected, and the temperature of the battery module 5 may be adjusted, depending on the air conditioning mode of the vehicle interior.

In addition, according to the present disclosure, by employing the gas injection device 30 selectively operating in the selected air conditioning mode of the vehicle interior, the flow rate of the refrigerant may be increased, and the cooling and heating performance may be improved.

In addition, according to the present disclosure, by using the single heat-exchanger 31 configured to heat-exchange at least two refrigerants having different temperatures and states with each other for the entire system and the gas injection device 30, the total number of components may be minimized.

In addition, according to the present disclosure, the performance of the system can be maximized by using the gas injection device 30 while minimizing the number of components, so that streamlining and simplification of the system may be achieved.

In addition, according to the present disclosure, by efficiently adjusting the temperature of the battery module 5, the optimal performance of the battery module 5 may be obtained, and through efficient management of the battery module 5, the overall travel distance of the vehicle may be increased.

In addition, according to the present disclosure, through streamlining of an entire system, it is possible to reduce manufacturing cost and weight and improve space utilization.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: first coolant line
3: heating device
4: second coolant line
5: battery module
10: compressor
11: refrigerant line
12: condenser
13: receiver dryer
14: first expansion valve
15: evaporator
20: chiller
21: connection line
23: second expansion valve
30: gas injection device
31: heat-exchanger
31a: first heat exchanger device
31b: second heat-exchanger device
32: first line
33: third expansion valve
34: second line

What is claimed is:

1. A heat pump system for a vehicle, the heat pump system comprising:
a compressor configured to compress a refrigerant;
a condenser connected to the compressor through a refrigerant line, the condenser configured to condense the refrigerant;
a first expansion valve connected to the condenser through the refrigerant line;
an evaporator connected to the first expansion valve through the refrigerant line and connected to the compressor through the refrigerant line, the evaporator configured to evaporate the refrigerant supplied from the refrigerant line;
a connection line including a first end connected to the refrigerant line between the condenser and the first expansion valve, and a second end connected to the refrigerant line between the compressor and the evaporator;
a chiller provided on the connection line, and configured to adjust a temperature of a coolant by exchanging heat between the refrigerant introduced through the connection line and a selectively introduced coolant;
a second expansion valve provided on the connection line at an upstream end of the chiller;
a heat-exchanger connected to the refrigerant line connecting the condenser and the first expansion valve, and the refrigerant line connecting the evaporator and the compressor; and
a gas injection device including the heat-exchanger, provided on the refrigerant line between the condenser and the first expansion valve, configured to expand the refrigerant selectively introduced from the condenser and supply the refrigerant expanded by the gas injection device to the heat-exchanger, and configured to supply the refrigerant heat-exchanged in the heat-exchanger to the compressor, to increase a flow rate of the refrigerant circulating within the refrigerant line,
wherein, the flow rate of the refrigerant is controlled through an operation control of the gas injection device, based on at least one mode for adjusting a temperature of a vehicle interior.

2. The heat pump system of claim 1, wherein the gas injection device further comprises:
a first line having a first end connected to the refrigerant line between the condenser and the heat-exchanger, and a second end connected to the heat-exchanger;
a third expansion valve provided on the first line at an upstream end of the heat-exchanger; and
a second line having a first end connected to the heat-exchanger, and a second end connected to the compressor.

3. The heat pump system of claim 2, wherein the heat-exchanger comprises:
a first heat-exchange device configured to exchange heat between the refrigerant supplied from the condenser through the refrigerant line and the refrigerant supplied from the evaporator or the chiller;
a second heat-exchange device configured to exchange heat between the refrigerant supplied from the condenser through the refrigerant line, and the refrigerant expanded in the third expansion valve supplied through the first line; and
a barrier rib configured to partition the first heat-exchange device and the second heat-exchange device.

4. The heat pump system of claim 3, wherein the barrier rib is configured to:
allow the refrigerant supplied from the condenser to flow to the first heat-exchange device and the second heat-exchange device so that the refrigerant supplied from the condenser through the refrigerant line flows together in the first heat-exchange device and the second heat-exchange device; and
prevent the refrigerant supplied from the evaporator or the chiller to the first heat-exchange device through the refrigerant line from being mixed with the refrigerant supplied from the third expansion valve to the second heat-exchange device through the first line.

5. The heat pump system of claim 2, wherein, when the refrigerant expanded in the third expansion valve is supplied to the heat-exchanger through the first line, the heat-exchanger is configured to vaporize the refrigerant supplied from the third expansion valve through exchanging heat with the refrigerant supplied from the condenser so that the flow rate of the refrigerant circulating within the refrigerant line is increased, and the heat-exchanger is configured to supply the vaporized refrigerant to the compressor through the second line.

6. The heat pump system of claim 2, wherein, when an operation of the gas injection device is required, the third expansion valve is configured to expand the refrigerant supplied from the condenser through the first line, and supply the refrigerant expanded by the third expansion valve to the heat-exchanger.

7. The heat pump system of claim 3, wherein the at least one mode comprises:
a first cooling mode for cooling the vehicle interior, wherein the gas injection device is not operated in the first cooling mode;
a second cooling mode for cooling the vehicle interior, wherein the gas injection device is operated in the second cooling mode;
a first heating mode for heating the vehicle interior, wherein the gas injection device is not operated in the first heating mode; and
a second heating mode for the heating the vehicle interior, wherein the gas injection device is operated in the second heating mode.

8. The heat pump system of claim 7, wherein, in the first cooling mode:
the refrigerant line interconnecting the compressor, the condenser, the first expansion valve, and the evaporator is configured to be opened;
the first line is configured to be closed by the third expansion valve;
the second line is configured to be closed;
the first expansion valve is configured to expand the refrigerant introduced through the refrigerant line and supply the refrigerant expanded by the first expansion valve to the evaporator;
the third expansion valve is configured to stop operating; and
the heat-exchanger is configured to exchange heat between the refrigerant passing through the first heat-exchange device from the condenser and the refrigerant passing through the first heat-exchange device from the evaporator.

9. The heat pump system of claim 8, wherein, when cooling of a battery module is required in the first cooling mode:
the connection line is configured to be opened by the second expansion valve;
the second expansion valve is configured to expand the refrigerant introduced through the connection line and supply the refrigerant expanded by the second expansion valve to the chiller; and
the refrigerant having passed through the chiller is configured to pass through the first heat-exchange device together with the refrigerant discharged from the evaporator.

10. The heat pump system of claim 7, wherein, in the second cooling mode:
the refrigerant line interconnecting the compressor, the condenser, the first expansion valve, and the evaporator is configured to be opened;
the first line is configured to be opened by the third expansion valve;
the second line is configured to be opened;
the first expansion valve is configured to expand the refrigerant introduced through the refrigerant line and supply the refrigerant expanded by the first expansion valve to the evaporator;
the third expansion valve is configured to expand the refrigerant introduced through the first line, and supply the refrigerant expanded by the third expansion valve to the heat-exchanger through the first line;
the first heat-exchange device in the heat-exchanger is configured to exchange heat between the refrigerant passing through the first heat-exchange device from the condenser and the refrigerant passing through the first heat-exchange device from the evaporator; and
the second heat-exchange device in the heat-exchanger is configured to exchange heat between the refrigerant passing through the second heat-exchange device from the condenser and the refrigerant passing through the second heat-exchange device from the third expansion valve, and supply the gaseous refrigerant to the compressor through the opened second line.

11. The heat pump system of claim 10, wherein, when cooling of a battery module is required in the second cooling mode:
the connection line is configured to be opened by the second expansion valve;
the second expansion valve is configured to expand the refrigerant introduced through the connection line and supply the refrigerant expanded by the second expansion valve to the chiller; and
the refrigerant having passed through the chiller is configured to pass through the first heat-exchange device together with the refrigerant discharged from the evaporator.

12. The heat pump system of claim 7, wherein, in the first heating mode:
a portion of the refrigerant line connecting the compressor and the condenser is configured to be opened;
a portion of the refrigerant line connecting the condenser to the first end of the connection line and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
the first line is configured to be closed by the third expansion valve;
the second line is configured to be closed;
the first expansion valve is configured to stop operating;
the second expansion valve is configured to expand the refrigerant introduced through the connection line and supply the refrigerant expanded by the second expansion valve to the chiller;
the third expansion valve is configured to stop operating; and
the heat-exchanger is configured to exchange heat between the refrigerant passing through the first heat-exchange device from the condenser and the refrigerant passing through the first heat-exchange device from the chiller.

13. The heat pump system of claim 7, wherein, in the second heating mode:
a portion of the refrigerant line connecting the compressor and the condenser is configured to be opened;
a portion of the refrigerant line connecting the condenser to the first end of the connection line and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
the first line is configured to be opened by the third expansion valve;
the second line is configured to be opened;
the first expansion valve is configured to stop operating;
the second expansion valve is configured to expand the refrigerant introduced through the connection line and supply the refrigerant expanded by the second expansion valve to the chiller;
the third expansion valve is configured to expand the refrigerant introduced through the first line, and supply the refrigerant expanded to by the third expansion valve to the heat-exchanger through the first line;
the first heat-exchange device in the heat-exchanger is configured to exchange heat between the refrigerant passing through the first heat-exchange device from the condenser and the refrigerant passing through the first heat-exchange device from the chiller; and
the second heat-exchange device in the heat-exchanger is configured to exchange heat between the refrigerant passing through the second heat-exchange device from the condenser and the refrigerant passing through the second heat-exchange device from the third expansion valve, and supply the gaseous refrigerant to the compressor through the opened second line.

14. The heat pump system of claim 2, wherein the second expansion valve and the third expansion valve are 2-way electronic expansion valves configured to selectively expand the refrigerant while controlling the flow rate of the supplied refrigerant.

15. The heat pump system of claim 1, further comprising a receiver dryer provided on the refrigerant line between the condenser and the heat-exchanger.

16. The heat pump system of claim 1, further comprising a battery module through which a first coolant circulates, and a heating device in which a second coolant circulates to heat the vehicle interior by using a high-temperature coolant,
wherein the condenser is connected to the heating device through a first coolant line along which the second coolant circulates, and
wherein the chiller is connected to the battery module through a second coolant line along which the first coolant circulates.

17. The heat pump system of claim 16, wherein, when heating the vehicle interior, the first coolant line is configured to be opened to connect the condenser and the heating device.

18. The heat pump system of claim 16, wherein, when the battery module is to be cooled while cooling the vehicle interior, or when a waste heat of the battery module is to be recollected at a time of heating the vehicle interior, the second coolant line is configured to be opened to connect the chiller and the battery module.
